(19) United States
(12) Patent Application Publication
(10) Pub. No.: US 2022/0343433 A1
(43) Pub. Date: Oct. 27, 2022

(54) SYSTEM AND METHOD THAT RANK BUSINESSES IN ENVIRONMENTAL, SOCIAL AND GOVERNANCE (ESG)

(71) Applicant: THE DUN AND BRADSTREET CORPORATION, Short Hills, NJ (US)

(72) Inventors: Jingtao Jonathan Yan, Princeton, NJ (US); Alla Kramskaia, Warren, NJ (US); Rochelle March, Brooklyn, NY (US)

(73) Assignee: THE DUN AND BRADSTREET CORPORATION, Short Hills, NJ (US)

(21) Appl. No.: 17/831,985

(22) Filed: Jun. 3, 2022

Related U.S. Application Data
(60) Provisional application No. 63/123,497, filed on Dec. 10, 2020.
(60) Provisional application No. 63/247,647, filed on Sep. 23, 2021.
(60) Provisional application No. 63/309,013, filed on Feb. 11, 2022.

(51) Int. Cl. G06Q 40/06

(52) U.S. Cl. CPC G06Q 40/06

(57) ABSTRACT

There is provided a method that includes (a) receiving data indicative of an environmental (E), social (S) and governance (G) objective, and measurements of ESG components, (b) creating a set of N-grams for each ESG component, (c) searching a database, based on the set of N-grams, to obtain ESG data, and (d) generating an ESG score based on the ESG data. There is also provided a system that performs the method.

### CROSS-REFERENCED APPLICATIONS

This application claims priority to U.S. Provisional Application No. 63/213,497, filed on Jun. 22, 2021, 63/247,647, filed on Sep. 23, 2021, and 63/309,013, filed on Feb. 11, 2022, all of which are incorporated herein in their entireties by reference thereto.

### BACKGROUND OF THE DISCLOSURE

### 1. Field of the Disclosure

The present disclosure relates to environmental, social and governance metrics (ESG), and more particularly, to a technique for developing an ESG rankings dataset and generating an ESG score for a business.

### 2. Description of the Related Art

The approaches described in this section are approaches that could be pursued, but not necessarily approaches that have been previously conceived or pursued. Therefore, the approaches described in this section may not be prior art to the claims in this application and are not admitted to be prior art by inclusion in this section.

All trademarks mentioned herein are the property of their respective owners.

ESG has been around for more than a century. It originated primarily with socially conscious investors who wanted to align their investments with their values, but it has become mainstream with the emergence of more and better data and understanding of the environmental and social pressures of modernity.

The pressures that have helped put ESG in the spotlight include macro drivers like increased resource scarcity and impacts on productivity from natural disasters, such as winter storm Uri in Texas. They also stem from the increasing expectation that corporations should commit to improving social outcomes, from addressing inequality and diversity representation to meeting several of the socially oriented United Nations Sustainable Development Goals (SDGs)

ESG data tends to capture extra-financial factors that were traditionally absent in financial analysis, such as company management of energy and water use, waste generation, employee rights and working conditions, community engagement, data privacy rights, and more traditional indicators of corporate accountability and transparency. While ESG is traditionally not seen as material to business outcomes, evidence increasingly shows that there is a strengthening financial relationship to it. Alpha is a measurement of the performance of a stock in relation to the overall market. The exact relationship is inconclusive, but ESG has become a popular strategy for identifying additional alpha and managing market volatility. For example, in April 2020, at the start of the COVID-19 recession, multiple ESG funds experienced smaller downfalls than those of common benchmarks such as the S&P 500®. In a world that has changed considerably since the profit-prioritizing Industrial Revolution, it is fitting that a new genre of company analysis via ESG factors can guide us.

ESG data has evolved considerably since the early days of socially responsible investing, when negative screenings eliminated investment in controversial sectors such as tobacco, alcohol, gambling, and weapons. A handful of niche commercial and non-profit data providers emerged in the early 2000s to collect and organize additional information on companies as ESG norms changed. By the 2010s, several major global players had emerged, primarily through the acquisition of these earlier niche providers.

Two main trends have fueled the expansion of ESG data, namely (1) increasing corporate disclosure, and (2) investor uptake. Of companies on the S&P 500® in 2020, 90% published sustainability reports, compared with only 20% in 2011, and 96% of the world's largest 250 companies reported on their sustainability performance. On the investor side, inflows of ESG assets have increased significantly, bringing in more than $21 billion in the first quarter of 2021 alone, on track to beat the previous record of $51 billion in 2020. These trends are expected to accelerate, as is more directive regulation concerning the disclosure of ESG factors, such as the recent Sustainable Finance Disclosure Regulation (SFDR) and EU Taxonomy in Europe and stock index requirements in Asia; and there are discussions in the U.S. Congress about standardization of mandatory climate risk disclosures.

To date, ESG scores on companies are primarily derived from company disclosure, whether from annual reports, ESG reports (also labeled as sustainability, corporate social responsibility, or impact reports), and financial filings. Because of this, updating of ESG data is limited to yearly cycles as new reports are published and this data is collected. While company disclosure has increased, it remains non-standardized and even rare for ESG data, and providers may use varying factors for calculating the same ESG topics (e.g., workplace health and safety). Several ESG factors, particularly for environmental impacts, are often modeled using generic segmentation such as sector, size, and location of a company, given limited and varied disclosure. In addition, data collection is often inclusive of only public companies, given the reliance on obtaining ESG data from reporting.

Some companies also request distinct information directly from other companies that is not shared widely but can be included in aggregated or normalized ESG scores. This data is often not standardized between providers and may capture significantly different attributes of ESG performance. It is also voluntarily self-reported data that may not be authentic. While the volume of ESG data now assured by third parties is increasing, that assurance often refers only to the data collection processes and not to the actual data itself. In addition, often only a small amount of ESG data can be assured, including greenhouse gas (GHG) emissions and, in lesser instances, energy consumption, water consumption, and waste generation. Assurance of ESG metrics will likely increase as regulations require it.

Because of non-standardization of company disclosure, as well as the collection of additional data from sources such as news and the media, ESG data providers often require a manual review of the data by an analyst. This has benefits in terms of capturing nuances around ESG disclosure, and it is the preferred approach for providing ESG in a traditional or associated rating, such as for providers like S&P Global and Moody's. However, manual evaluation of companies can also introduce bias that can result in inconsistencies and issues regarding company comparability. Manual analysis is also resource-intensive. These factors have resulted in a new wave of ESG providers quickly entering the market by providing ESG data collected via artificial intelligence (AI) and machine learning (ML) methods such as scraping reports and news channels using natural language processing (NLP), which automatically processes human language in a computational manner.

As ESG data covers a broad spectrum of issues, emerging data collection methods including geospatial data from satellites, sensor data from the use of the industrial internet of things and the internet of things, and the application of advanced AI and ML analytics to additional datasets, will likely uncover additional and potentially more accurate modes of measuring ESG-related metrics.

Once collected, data can be standardized through a process of normalization to allow comparing and aggregation of different metrics containing differing units. For example, 1,000 tons of carbon dioxide equivalent (tCO₂e) can be converted to a number between 0 and 100 depending on the included maximum and minimum values in the sample, which may be the entire universe of companies or only companies in the same industry. Metrics can be aggregated to more general themes, such as environmental performance, which can be rolled up again into an overall ESG score.

Before such aggregation, however, topic-specific weighting can be applied based on the importance, or materiality, of that topic to the company's sector. The Sustainable Accounting Standards Board (SASB) Materiality Map™, for example, provides a matrix that illustrates which ESG topics are considered financially material to distinct sectors. Weighting of topics can also vary depending on preference, such as weighting diversity more heavily because it is considered of greater importance to specific stakeholders. This latter approach is more common in impact metrics and investing, which is focused more on longer-term outcomes that may yield a smaller financial performance than traditional benchmarks until later years.

It is desirable to obtain meaningful and consistent ESG data on public and private businesses. The present document describes an approach and methods for an ESG rankings dataset that includes real ESG data factors on millions of public and private companies, and is constantly expanding in company coverage.

The following documents provide some background on some of the concepts discussed in the present document, and their content is herein incorporated by reference:
U.S. Pat. No. 8,036,907, entitled “Method and system for linking business entities using unique identifiers”;
U.S. Pat. No. 8,438,183, entitled “Statistical record linkage calibration for interdependent fields without the need for human interaction”;
U.S. Pat. No. 9,390,176, entitled “System and method for recursively traversing the internet and other sources to identify, gather, curate, adjudicate, and qualify business identity and related data”;
U.S. Pat. No. 10,454,878, entitled “System and method for identity resolution across disparate distributed immutable ledger networks”;
US Patent Publication No. 20150178645, entitled “Discovering a business relationship network, and assessing a relevance of a relationship”; and
US Patent Application Publication No. 20180225389, entitled “System and method of creating different relationships between various entities using a graph database”.

How do you objectively quantify and measure a business in terms of its Environmental, Social, and Governance? There are many rudimentary ways in current market, but their assessment scores are mostly skewed towards certain aspect of ESG, or containing largely subjective judgements in data creation. There is a need for a technical method that comprehensively calculates a numeric score of a business.

### SUMMARY

The present document discloses a method that includes (a) receiving data indicative of an environmental (E), social (S) and governance (G) objective, and measurements of ESG components, (b) creating a set of N-grams for each ESG component, (c) searching a database, based on the set of N-grams, to obtain ESG data, and (d) generating an ESG score based on the ESG data. There is also provided a system that performs the method.

### BRIEF DESCRIPTION OF THE DRAWINGS

FIG. 1 is a block diagram of system for generating an ESG ranking.

FIG. 2 is a conceptual diagram of an ESG ranking method.

FIG. 3 is a conceptual block diagram of a method for big data collection and generation.

FIG. 4 is a flowchart for a method of web-scraping and NLP analysis.

FIG. 5 is a flowchart of a method of news NLP analysis.

FIG. 6 is a flowchart of a method for NLP and topic tagging.

FIG. 7 is a flowchart of a method for sentiment analysis.

FIG. 8 is a table of ESG rankings dataset's topic architecture.

FIG. 9 is a flowchart of a high-level methodology for ESG ranking.

FIG. 10 is a table of example data for ESG topics of supplier engagement and environmental opportunities.

FIG. 11 is a table of illustrative scores for ESG themes across various data sources.

FIG. 12 is a table of overall ESG scores across sources.

FIG. 13 is a table of overall ESG factor scores that fall between thresholds that then inform the final ESG rankings.

FIG. 14 is a table of the keywords related to topics.

FIG. 15 is a table of examples of some predictors used in ESG.

FIG. 16 is a table of an example of execution of methods of NLP and topic and theme tagging, and sentiment analysis.

FIG. 17 is a table of topic weights related to a sector for gas utilities and distributors.

FIG. 18 is a table of an example calculation of the score for the Natural resources theme.

FIG. 19 is a table of an example calculation of an environment score.

FIG. 20 is a table of an exemplary calculation of an ESG score.

A component or a feature that is common to more than one drawing is indicated with the same reference number in each of the drawings.

### DETAILED DESCRIPTION OF THE PREFERRED EMBODIMENTS

To compose an ESG score, the techniques disclosed herein build on efforts present in the current ESG landscape and provide transparency on ESG performance across public and private companies. The techniques employ an ESG rankings dataset that will contribute to the ESG data landscape by providing the following:

(A) Wide coverage of both public and private companies based on a consistent approach. Today, there is a paucity of data on private companies, as these companies are not required to submit annual reports and filings on their performance. Where there is ESG data on private companies, it was often collected using methods that differ considerably from those of public companies. Through multiple venues, Dun & Bradstreet reports on more than 420 million public and private companies on data related to their performance and trade. This data includes many topics that are important to ESG performance and offers existing channels for additional information related to environmental and social topics. This enables wide coverage and a consistent approach for compiling the ESG rankings dataset for companies.

(B) Scores that are informed by real data, the majority of which is verified information. Due to lack of data standardization and the paucity of some data points, most ESG scores model data using a broad segmentation approach based on general variables such as company sector, location of headquarters, and/or revenue size. To limit the use of modeling, the ESG rankings dataset leverages Dun & Bradstreet data, which is real data collected on and from companies. Other data sources, such as news and company reports, are triangulated with additional data collected by Dun & Bradstreet in order to confirm their veracity. The variable, GHG emissions, which is infrequently disclosed is modeled for a subset of companies using numerous firm-specific variables.

(C) Emphasis on the importance of metrics to company stability and financial performance. The techniques disclosed herein strive to ensure that a company's ESG ranking would be of use to its customers, particularly with regard to third-party risk and financial risk management. Results were tested and validated to ensure they provided insights into how companies' resiliency is impacted by ESG performance. Rigorous testing resulted in specified weighting for individual ESG factors if these factors were found to be correlated with company stability, measured by financial growth and operational continuity. Weighting specific ESG topics per sector strengthened the positive correlation of the ESG rankings dataset with net income, return on sales, and stock market performance, and the negative correlation with delinquency rates. Aggregating a massive array of ESG-related data into manageable indicators that are decision-useful has been one of the long-term goals of the sustainability field.

(D) Updated data provided on a monthly basis. The business landscape is rapidly changing, and so should the data that describes its impact on environmental and social factors. Because ESG data is so often reliant on publicly available reports and filings that might be refreshed on an annual basis at most, ESG data is often limited in its update frequency. While the ESG rankings dataset also ingests this type of data, much of its private data is gathered throughout the year on a rolling basis, is updated consistently, and can be processed quickly in order to be available to customers. For example, for the ESG rankings dataset, data is processed weekly, and updates are available monthly.

Building on the points above as well as on a mature and rapidly evolving ESG data landscape, the ESG rankings dataset will provide decision-useful metrics across a wide range of companies. Below, there is provided more detail on the methods used to create the ESG rankings dataset.

To compose an ESG score, an ESG rankings dataset will preferably contribute to the ESG data landscape as follows:
(a) Wide coverage of both public and private companies using a consistent approach.
(b) Scores that are informed by real data, the majority of which is verified information.
(c) Emphasis on the importance of metrics to company stability and financial performance.
(d) Updated data provided monthly.

The ESG rankings dataset's topic architecture was created by referencing several of the leading ESG standards. Data is sourced, collected, and quality-checked through various processes. In preparation for analytical modeling and calculations, the data is further normalized, processed, and weighted. The outputs are various ESG-related rankings as well as overall scores. The ESG outputs are calculated to create data that is normally distributed between 1, indicating low risk or best performance, and 5, indicating high risk or worst performance.

The ESG rankings dataset offers a decision-useful set of metrics that can be used in multiple applications, such as supply chain management, investing, lending and credit evaluation, insurance inputs, and even sales and marketing segmentation. Aggregating a massive array of ESG-related data into manageable indicators that are decision-useful has been one of the long-term goals of the sustainability field.

An existing ESG rankings dataset was tested for robustness, and the testers recognized areas for refinement. These areas include (a) the focus of existing workstreams that increase data availability through more granular and broad data acquisition as well as further use of modeling, where appropriate, (b) refinement of NLP libraries and analysis to filter out “greenwashing”, and (c) harmonizing of local ESG data availability in an ESG dataset with global coverage. Developing ESG products that provide depth around specific risks or trends, such as climate impact or emerging regulations, are also part of providing a wide range of useful and valuable intelligence on the ESG metrics for public and private companies.

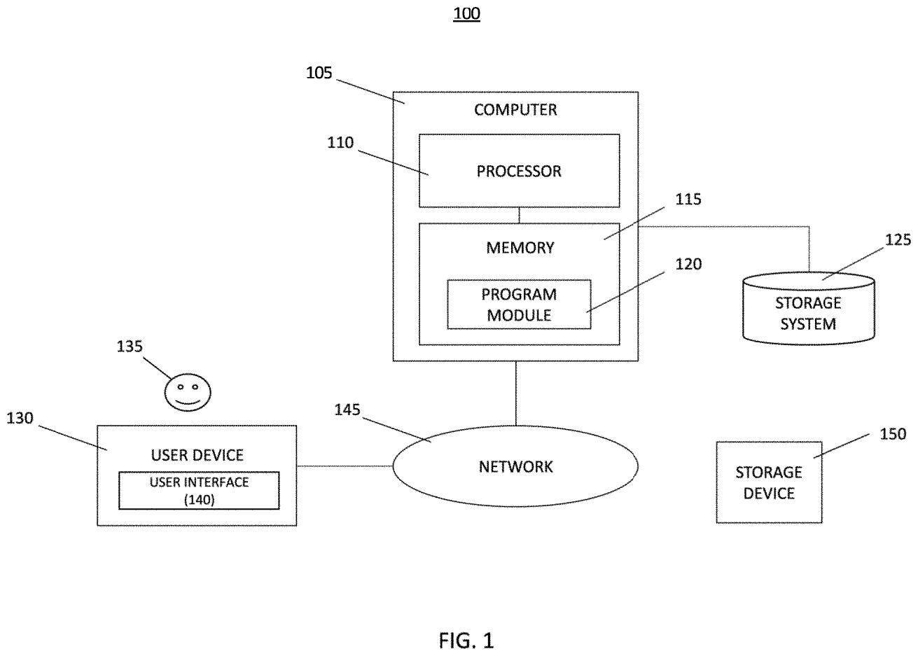

FIG. 1 is a block diagram of system, namely system 100, for generating an ESG ranking. System 100 includes a computer 105 coupled to a network 145 and a storage system 125.

Network 145 is a data communications network. Network 145 may be a private network or a public network, and may include any or all of (a) a personal area network, e.g., covering a room, (b) a local area network, e.g., covering a building, (c) a campus area network, e.g., covering a campus, (d) a metropolitan area network, e.g., covering a city, (e) a wide area network, e.g., covering an area that links across metropolitan, regional, or national boundaries, (f) the Internet, or (g) a telephone network. Communications are conducted via network 145 by way of electronic signals and optical signals that propagate through a wire or optical fiber, or are transmitted and received wirelessly.

Computer 105 includes a processor 110, and a memory 115 that is operationally coupled to processor 110. Although computer 105 is represented herein as a standalone device, it is not limited to such, but instead can be coupled to other devices (not shown) in a distributed processing system.

Processor 110 is an electronic device configured of logic circuitry that responds to and executes instructions.

Memory 115 is a tangible, non-transitory, computer-readable storage device encoded with a computer program. In this regard, memory 115 stores data and instructions, i.e., program code, that are readable and executable by processor 110 for controlling operations of processor 110. Memory 115 may be implemented in a random access memory (RAM), a hard drive, a read only memory (ROM), or a combination thereof. One of the components of memory 115 is a program module 120.

Program module 120 contains instructions for controlling processor 110 to execute processes described herein.

The term “module” is used herein to denote a functional operation that may be embodied either as a stand-alone component or as an integrated configuration of a plurality of subordinate components. Thus, program module 120 may be implemented as a single module or as a plurality of modules that operate in cooperation with one another. Moreover, although program module 120 is described herein as being installed in memory 115, and therefore being implemented in software, it could be implemented in any of hardware (e.g., electronic circuitry), firmware, software, or a combination thereof.

While program module 120 is indicated as being already loaded into memory 115, it may be configured on a storage device 150 for subsequent loading into memory 115. Storage device 150 is a tangible, non-transitory, computer-readable storage device that stores program module 120 thereon. Examples of storage device 150 include (a) a read only memory, (b) an optical storage medium, (c) a hard drive, (d) a memory unit consisting of multiple parallel hard drives, (e) a universal serial bus (USB) flash drive, (f) a RAM, and (g) an electronic storage device coupled to computer 105 via network 145.

Storage system 125 is a storage device, for example, a hard drive or a database system, on which processor 110 stores data.

A user 135 uses a user device 130 that is communicatively couped to network 145. User device 130 includes a user interface 140.

User interface 140 includes an input device, such as a keyboard, speech recognition subsystem, or gesture recognition subsystem, for enabling user 135 to communicate information to and from computer 105 via network 145. User interface 140 also includes an output device such as a display or a speech synthesizer and a speaker. A cursor control or a touch-sensitive screen allows user 135 to utilize user interface 140 for communicating additional information and command selections to computer 105.

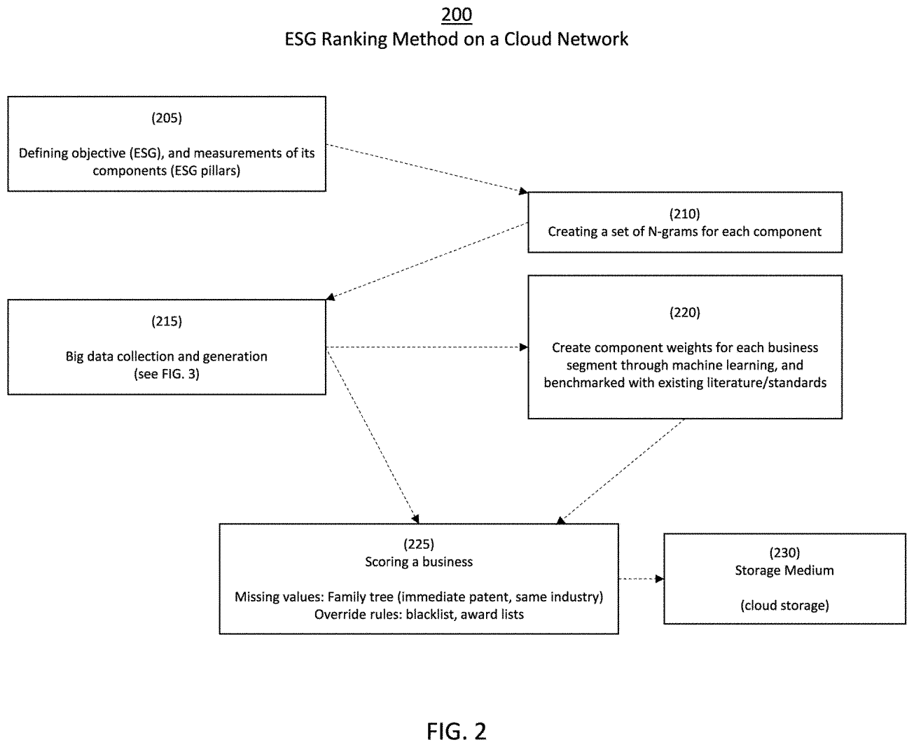

FIG. 2 is a conceptual diagram of an ESG ranking method, namely method 200, performed by system 100 on a cloud network.

In operation 205, user 135 communicates with computer 105, and more specifically processor 110, via user interface 140, and defines an objective (ESG) and measurements of its components (ESG pillars).

In operation 210, processor 110 creates a set of N-grams for each component. An N-gram is a phrase having a quantity of N words. For example, “my black cat” is a 3-gram.

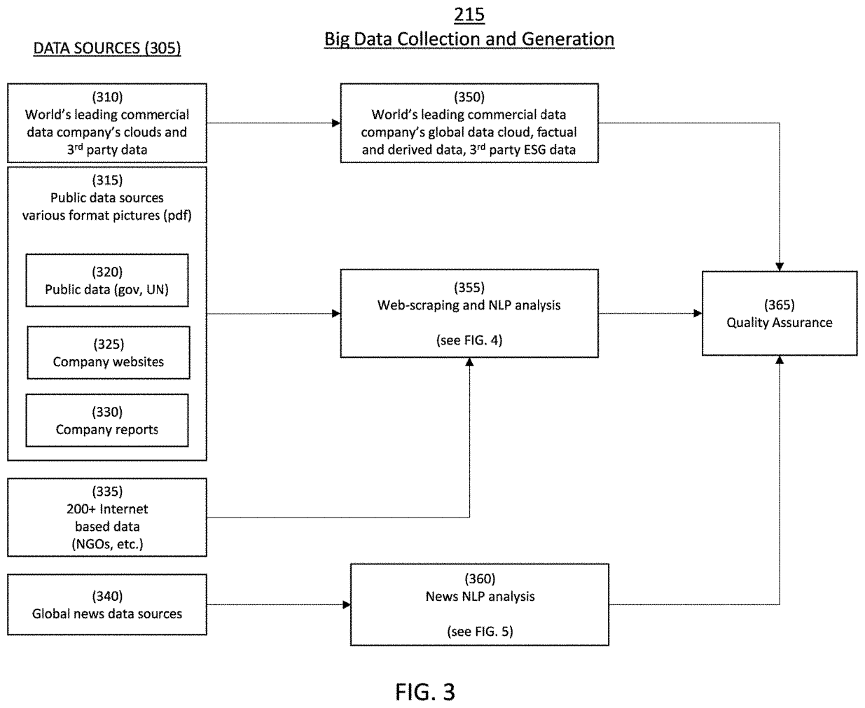

In operation 215, processor 110 performs big data collection and generation (see FIG. 3).

In operation 220, processor 110 creates component weights for each business segment through machine learning, and benchmarked with literature/sustainability standards that are based on the importance, or materiality, of ESG components to the business segment

In operation 225, processor 110 scores a business. The data collected from operation 215 and the weights created in operation 220 are used together for scoring in operation 225. It obtains missing values from a family tree (immediate parent, same industry). Override rules are utilized for blacklist and award lists.

In operation 230, ESG ranking data is stored in storage system 125.

FIG. 3 is a conceptual block diagram of big data collection and generation, as performed by operation 215.

Operation 215 receives data from data sources 305, which include data sources 310, 315, 335 and 340.

Data sources 310 include the world's leading commercial data company's clouds and 3^{rd} party data sources. Examples include Green List, Global Diversity List, spend data, inquiry data, Global Archive, comprehensive global database of business information, small business risk insights, CountryRisk, Risk scores (SSI/SER), and GHG Emission.

Data sources 315 are public data sources, which may include data in various format pictures, e.g., PDF. Data sources 315 include (a) public data 320, (b) company websites 325, and (c) company reports 330.

Public data 320 includes data from government, e.g., SEC, and United Nations sources, and includes Form 10-K, proxy statements, annual reports, EPA, OSHA, EPLS and OFAC.

Company websites 325 includes text contained in ESG-related URLs under company domains, and CSR reports.

Data sources 335 are internet-based data sources and NGOs.

Data sources 340 are global news data sources, such as global news feeds from premier global news providers.

Operation 215 includes several subordinate operations, namely operations 350, 355, 360 and 365.

In operation 350, processor 110 receives data from data sources 310, and processes the world's leading commercial data company data cloud, factual and derived data, and 3^{rd} party ESG data.

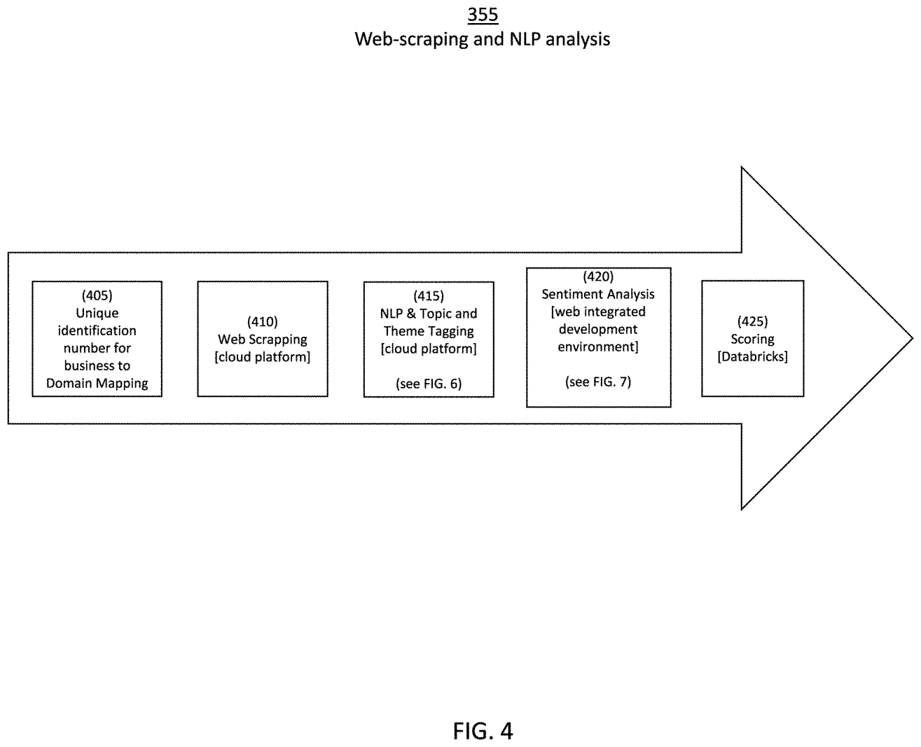

In operation 355, processor 110 receives data from data sources 315 and 335, and performs web-scraping and NLP analysis (see FIG. 4). For example, for company reports 330, processor 110 performs text NLP and image recognition on board member gender.

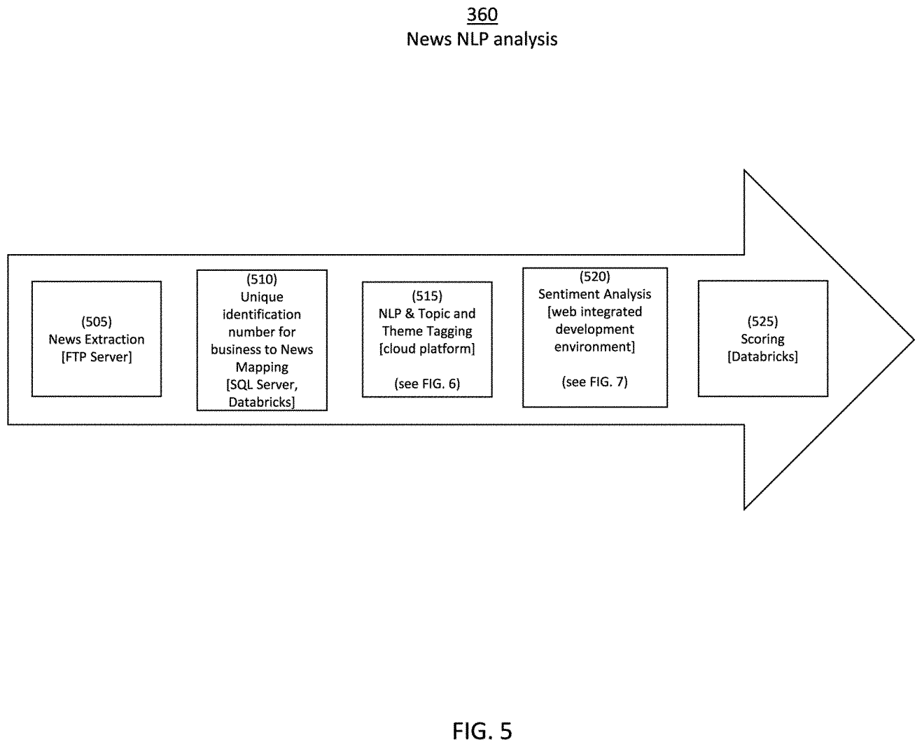

In operation 360, processor 110 receives data from data sources 340, and performs news NLP analysis (see FIG. 5).

In operation 365, processor 110 performs quality assurance on results of operations 350, 355 and 360.

Many data are missing or not available for generation of an ESG index. Such data can be derived through machine learning. Examples of such data include CO2e GHG emission predictions, electricity predictions, and climate perils impacts on business performance.

FIG. 4 is a flowchart for a method of web-scraping and NLP analysis, as performed in operation 355.

In operation 405, processor 110 performs domain mapping for numeric identifier of a business entity.

In operation 410, processor 110 performs web scrapping, which includes:
(a) obtaining a list of hyperlinks present on a home page of a website;
(b) shortlisting relevant URLs based on a list of E, S, and G keywords;
(c) scraping data present on shortlisted webpages; and
(d) performing NLP on the data, and image processing on pictures.
   Thus, the web scraping is performed on data of various formats.

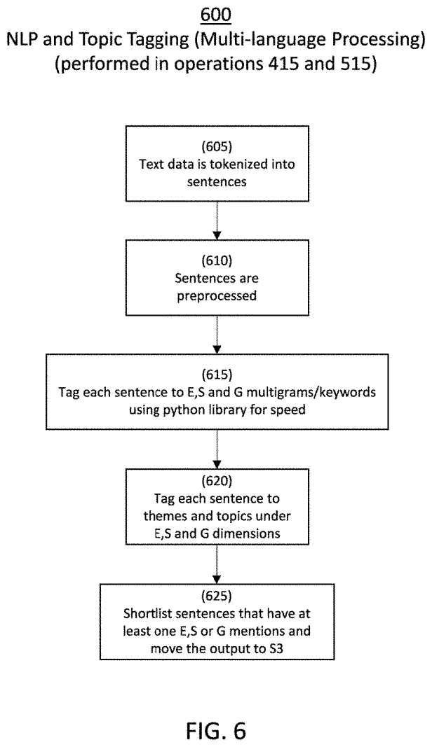

In operation 415, processor 110 performs natural language processing & topic and theme tagging (see FIG. 6, which includes:
(a) Text data collected as paragraphs/documents from web sources is split to sentence level and then these sentences are preprocessed by removing special characters.
(b) Preprocessed sentences are now tagged to ESG components (themes, topics) based on N grams of operation 210.

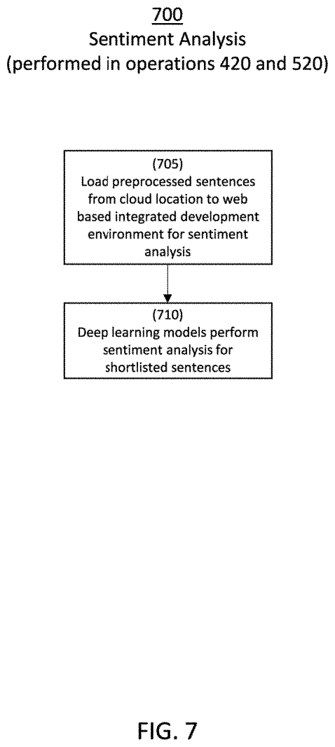

In operation 420, processor 110 performs sentiment analysis (see FIG. 7). Sentimental analysis is to analyze text for understanding the opinion expressed by it. Typically, we quantify this sentiment with a positive, negative, or neutral value.

In operation 425, processor 110 performs ESG scoring based on processed web data. In ESG scoring:
(a) ESG transformed values for each text statement is based on polarity assigned in operation 420, where positive statements are given values of +1, negative statements are assigned with values of −1.
   (b) Topic score is calculated based on average of processed ESG data values.
(c) Theme score is calculated by weighted average of corresponding topic scores.
(d) Dimension score (Environment/social/governance) score is obtained by weighted average of corresponding topic scores.
(e) ESG score of web data is then calculated by weighted average of all available topic scores.

FIG. 5 is a flowchart of new NLP analysis, as performed in operation 360.

In operation 505, processor 110 performs news extraction. News extraction involves collection of news data pertaining to companies globally via file transfer protocol server received from premier news data provider.

In operation 510, processor 110 performs news mapping for numeric identifier of business entity thereby identifying the company corresponding to the news received.

In operation 515, processor 110 performs NLP & topic theme tagging (see FIG. 6), which includes:
(a) News data collected as paragraphs is split to sentence level and then these sentences are preprocessed by removing special characters.
(b) Preprocessed sentences are now tagged to ESG components (themes, topics) based on N grams of operation 210.

In operation 520, processor 110 performs sentiment analysis (see FIG. 7).

hi operation 525, processor 110 performs ESG scoring based on processed news data. In ESG scoring:
(a) ESG transformed values for each text statement is based on polarity assigned in operation 420 where positive statements are given values of +1, negative statements are assigned with values of −1.
(b) Topic score is calculated based on average of processed ESG data values.
(c) Theme score is calculated by weighted average of corresponding topic scores.
(d) Dimension score (Environment/social/governance) score is obtained by weighted average of corresponding topic scores.
(e) ESG score of web data is then calculated by weighted average of all available topic scores.

FIG. 6 is a flowchart of a method 600 for NLP and topic tagging (multi-language processing), as performed in operations 415 and 515.

In operation 605, processor 110 tokenizes text data into sentences where large text data received as paragraphs/documents is split to sentences

In operation 610, processor 110 preprocesses sentences. Preprocessing involves cleaning of textual sentences by removal of special characters and other text cleaning operations.

In operation 615, processor 110 tags each sentence to E, S and G multigrams/keywords using python library for fast keyword searching for speed where the N grams obtained in operation 210 are searched within the sentences to classify them to E, S and G categories.

In operation 620, processor 110 tags each sentence to themes and topics under E, S and G dimensions based on detected E, S, G specific N grams identified within each sentence in operation 615.

In operation 625, processor 110 shortlists sentences that have at least one mention of E, S or G, and moves the output to storage system 125.

FIG. 7 is a flowchart of a method 700 for sentiment analysis, as performed in operations 420 and 520.

In operation 705, processor 110 loads preprocessed sentences from cloud storage location to web based integrated development environment for sentiment analysis.

In operation 710, processor 110 utilizes one or more a machine learning models such as Bidirectional Encoder Representations from Transformers (BERT) and Zero Shot to perform sentiment analysis for shortlisted sentences.

Processor 110 also performs business identity resolution, which includes:
(a) filtering social handles;
(b) filtering media, e.g., newspapers, radio and television;
(c) filtering government/non-profit organizations
(d) position/frequency of text
(e) differencing person from text;
(f) world's leading commercial data company trade style comparison; and
(g) business name on title of text, position of the text, and frequency of business name in the text.

Approach for Building the ESG Rankings Dataset

The ESG rankings dataset's topic architecture was created by referencing several of the leading ESG standards, including the SASB, the Global Reporting Initiative (GRI), the Task Force on Climate-related Financial Disclosures (TCFD), the CDP (formerly the Carbon Disclosure Project), the UN SDGs, and other notable sustainability reporting frameworks. Under each of the environmental (E), social (S), and governance (G) dimensions, specific themes were described, as well as another layer of specific topics that relate to each general theme. Once this framework was established, each of the ESG themes could then be populated with hundreds of variables sourced from various datasets. The ESG rankings dataset uses the SASB Sustainable Industry Classification System® taxonomy for sector classifications. According to SASB, this taxonomy categorizes companies into sectors and industries in accordance with a fundamental view of their business model, their resource intensity, their sustainability impacts, and their sustainability innovation potential. This sector classification is superior to other such systems, such as the Global Industry Classification Standard, for improving ESG issue identification per sector segment.

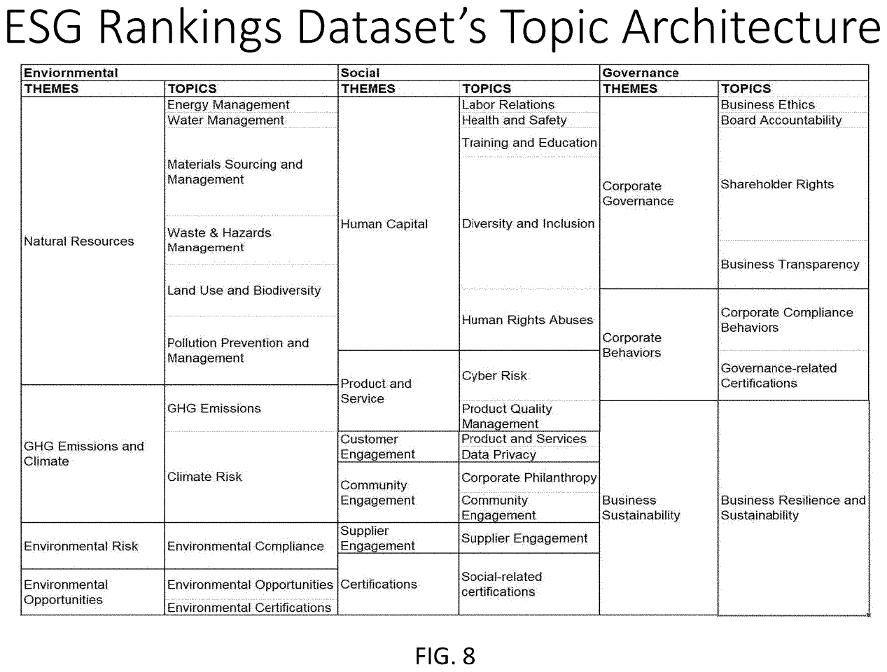

FIG. 8 is a table of ESG rankings dataset's topic architecture, and shows several exemplary themes and topics. In this example, there are 13 ESG themes.

The variables are ingested and quality checked through various processes. In preparation for analytical modeling and calculations, data is further normalized, processed, and weighted. The output is various ESG-related rankings as well as an overall score.

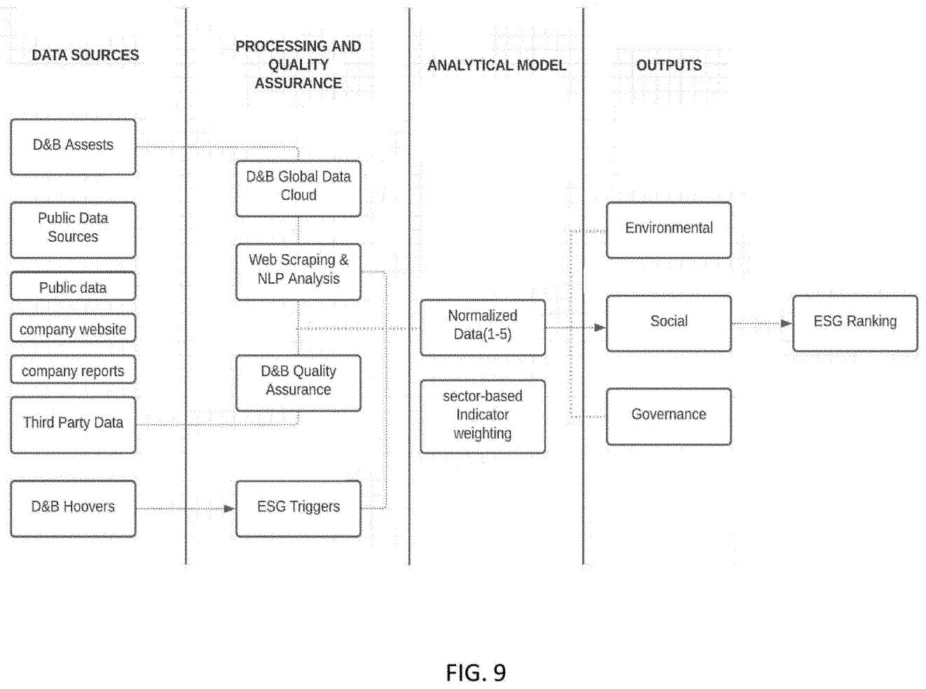

FIG. 9 is a flowchart of a high-level methodology for ESG ranking.

Data Sourcing and Collection

Data is first sourced through internal Dun & Bradstreet databases using analytical tools. This data was complemented with data from government sources (e.g., U.S. Environmental Protection Agency (EPA) compliance and environmental pollutant data), public sources (e.g., company reports and filings), news (e.g., processed through D&B Hoovers), and some third-party licensed data (e.g., aggregation of sustainability reports, GHG emissions from CDP). Companies can also directly submit additional ESG-related data through Dun & Bradstreet channels that can then be integrated into the ESG rankings dataset. The following are the examples of data sources for the ESG rankings dataset:
(a) Dun & Bradstreet proprietary business information;
(b) Legal documents and government websites;
(c) Global news;
(d) Non-governmental organization (NGO) evaluations and data sources;
(e) Third-party certifications;
(f) Company websites;
(g) Company sustainability reports, annual reports, and filings;
(h) Third-party licensed data; and
(i) Additional supplied ESG data from companies that is internally validated.

Processing and Quality Assurance

For all data ingested by system 100, variables are mapped to distinct company branches and parents. A single business entity is then assigned a numeric identifier, its Dun & Bradstreet D-U-N-S® Number. This allows easy identification and comparability of data from a company against other data about the same company, as well as efficient organization of company information. To be in the Dun & Bradstreet Data Cloud, data on companies goes through a strict data governance and quality process until it can be appended to a company's record. Company branches are assigned the ESG score associated with the company's headquarters, unless data is available on the branch level.

For textually based data, such as from company reports, websites, and news sources, topic extraction is done via NLP and deep learning. Keywords are organized in an ontology specific to the ESG domain. This is created through deep learning models such as Latent Dirichlet Allocation topic modeling, Google's pretrained word embeddings, word2vec, and evaluations from subject experts that inform testing. An ESG-BERT model is employed to detect polarity among keywords after models are trained using manually labeled sentences containing those keywords. These phrases are collected, evaluated, and organized into distinct keywords, bigrams (two keywords in one phrase), trigrams (three keywords in one phrase), and so on, that are combined across sources and averaged. Calculated averages are then normalized between −1 and 1 and mapped to an associated ESG topic.

In deep learning using word embedding, a word embedding is a numerical representation of texts that capture their meanings, semantic relationships and different types of contexts in which they are used. There are various methods to vectorize a text into a number. From simple count vectors map a word with a number of times of occurrence in a document to probabilistic and sophisticated deep learning methods. For example, a pre-trained word embedding may be a deep learning model trained on billions of words from news articles that fits these words in a high-dimensional vector space.

Other data from licensed, government, or NGO sources that includes discrete or continuous variables is collected via numerous modes such as web-scraping, existing data collection portals at Dun & Bradstreet, or data licenses and subscriptions. All data is cleaned, standardized, run through verification processes, and normalized between −1 and 1 before it is assigned to an ESG topic.

Analytical Model

Once the data is organized by ESG topic, weightings are applied that determine the final ESG topic score. If an ESG topic is not considered material to that company's sector as determined by Dun & Bradstreet's financial analysis, then a weight of 0 (zero) is assigned. In order to calculate an ESG topic score, there must be enough data to inform the variables that cover the financially material ESG topics. ESG topic scores then inform a larger ESG theme score that informs the overall ESG ranking. There must be enough ESG-related data available to adequately populate several of the themes, for example, five of the 13 ESG themes in the table in FIG. 8. As more data is ingested and becomes available, it is likely more companies will be assigned an ESG ranking.

Table 1, below, provides examples of ESG-related data per ESG topic.

TABLE 1
ESG-Related Data Per ESG Topic

| | | | | Indicative Data |
|---|---|---|---|---|
| Dimension | Theme | Topic | Description | Points |
| Environmental | Natural | Energy | Indicator of the | Total energy use |
| | resource | management | extent of a | (quantity, spend, |
| | management | | company's | type) |
| | | | energy | Renewable energy |
| | | | management | use |
| | | | efforts | Green energy |
| | | | | commitments |
| | | | | Energy efficiency |
| | | | | measures |
| | | Water | Indicator of the | Water consumption |
| | | management | extent of a | Water efficiency |
| | | | company's | Water reuse and |
| | | | water | replenishment |
| | | | management | Wastewater |
| | | | efforts | treatment and |
| | | | | permits |
| | | Materials | Indicator of a | Raw materials use |
| | | sourcing and | company's | in the supply chain |
| | | management | approach to the | Research and |
| | | | risk | development |
| | | | management, | investment in |
| | | | availability, | substitute materials |
| | | | and preferred | Pricing and |
| | | | policies related | availability of |
| | | | to procurement | resource use in a |
| | | | and materials | supply chain |
| | | | sourcing | Management of |
| | | | | risk through |
| | | | | product design, |
| | | | | manufacturing, and |
| | | | | end-of-life |
| | | | | management |
| | | Waste and | Indicator of the | Total weight of |
| | | hazards | extent of a | waste in metric |
| | | management | company's | tons |
| | | | waste | Waste reduction |
| | | | management | Percentage of |
| | | | efforts | hazardous waste |
| | | | | Percentage of |
| | | | | recycling |
| | | Land use and | Indicator of | Natural resource |
| | | biodiversity | policies and | extraction and |
| | | | impact related | cultivation |
| | | | to land use and | Impact on |
| | | | biodiversity | biodiversity loss |
| | | | loss | Habitat destruction |
| | | | | from land |
| | | | | acquisition |
| | | Pollution | Indicator of | Measurements |
| | | prevention and | policies and | taken to prevent |
| | | management | impact related | pollution and |
| | | | to pollution | reduce the amount |
| | | | management | of toxins entering |
| | | | | air, land, or water |
| | | | | environments |
| | | | | Adverse events |
| | | | | such as spills or |
| | | | | contamination |
| | | | | Remediation or |
| | | | | decontamination |
| | | | | efforts |
| | GHG | GHG | Indicator of the | Carbon emissions |
| | emissions and | emissions | measurement | GHG emissions |
| | climate | | and | (physical quantity |
| | | | management | of tCO2e, intensity |
| | | | of GHG | of tCO2e/$M) |
| | | | emissions | |
| | | Climate risk | Indicator of a | Climate risk and |
| | | | company's | disaster recovery |
| | | | awareness of | plans |
| | | | and readiness | Measurement of |
| | | | to address | climate risk, |
| | | | climate-related | including floods, |
| | | | impacts | hurricanes, |
| | | | | tornadoes, |
| | | | | droughts, wildfires, |
| | | | | etc. |
| | Environmental | Environmental | Indicator of a | Non-compliance |
| | risk | compliance | company's | with environmental |
| | | | adherence to | regulations |
| | | | environmental | Delays on |
| | | | regulations | regulatory |
| | | | | requirements, such |
| | | | | as permits |
| | | | | Companies on |
| | | | | environmental |
| | | | | “blacklists” and |
| | | | | “polluters' lists” |
| | Environmental | Environmental | Indicator of a | Clean tech |
| | opportunities | opportunities | company's | initiatives |
| | | | initiatives | Number of green |
| | | | toward | buildings |
| | | | sustainable and | Percentage of |
| | | | green activities | renewable energy |
| | | | | Sustainability |
| | | | | awards |
| | | Environmental | Indicator of | ISO 14000, ISO |
| | | certifications | whether a | 14001, ISO 14010, |
| | | | company has | ISO 14011 |
| | | | environmentally | LEED, Forest |
| | | | related | Stewardship |
| | | | certifications | Council, Marine |
| | | | associated with | Stewardship |
| | | | its branches | Council, USDA |
| | | | and | Organic, Fair |
| | | | headquarters | Trade, Rainforest |
| | | | | Alliance, etc. |
| Social | Human capital | Labor relations | Indicator of the | Responsible |
| | | | quality of | employer relations |
| | | | company and | Satisfactory rate |
| | | | employee | Layoff and hiring |
| | | | relationships | rates |
| | | | | Spend on |
| | | | | employees |
| | | | | (activities, |
| | | | | supplies, events) |
| | | Health and | Indicator of the | Total incident rate, |
| | | safety | extent of a | fatality rate, |
| | | | company's | vehicle incident |
| | | | responsibility | rate |
| | | | for employee | Spend on industrial |
| | | | health and | safety and |
| | | | safety | maintenance |
| | | | | Occupational |
| | | | | Safety and Health |
| | | | | Administration |
| | | | | compliance |
| | | Training and | Indicator of the | Average hours of |
| | | education | extent of a | training |
| | | | company's | Spend on human |
| | | | focus on | relations, training, |
| | | | employee | seminars, |
| | | | training and | educational |
| | | | education | materials |
| | | Diversity and | Indicator of the | Employee diversity |
| | | inclusion | demographic | ratio |
| | | | diversity | Gender ratio, |
| | | | within a | gender pay gaps |
| | | | company and | Minority-owned |
| | | | among its | business (racial |
| | | | leadership | minority, woman, |
| | | | | veteran, LGBTQ+, |
| | | | | disabled) |
| | | | | Board of directors |
| | | | | diversity; CEO |
| | | | | diversity |
| | | Human rights | Indicator of the | Human trafficking |
| | | abuses | coverage of | and human rights |
| | | | potential | data |
| | | | human rights | Conflict minerals |
| | | | abuses within a | and controversial |
| | | | company's | commodities |
| | | | operations | Child and forced |
| | | | | labor |
| | | | | Migrant rights |
| | Products and | Cyber risk | Indicator of the | Number of |
| | services | | vulnerability | cyberattack |
| | | | of a company | incidents |
| | | | to business | Number and cost of |
| | | | disruption | data breaches |
| | | | from cyber- | |
| | | | related | |
| | | | incidents | |
| | | Product quality | Indicator of | Internal and |
| | | management | investment and | external product |
| | | | activities | management |
| | | | related to the | processes and |
| | | | quality of a | procedures |
| | | | company's | Product recalls |
| | | | current and | New product |
| | | | future product | launches |
| | | | and service | Big data, data |
| | | | portfolios | center, or cloud |
| | | | | computing |
| | | | | initiatives |
| | | | | Food and Drug |
| | | | | Administration |
| | | | | approval |
| | | | | New IT contracts |
| | | | | Product quality and |
| | | | | safety; ISO 9001- |
| | | | | certified companies |
| | Customer | Products and | Indicator of a | Spend on |
| | engagement | services | company's | promotional |
| | | | investment and | materials |
| | | | activities | Working contact |
| | | | related to | numbers for |
| | | | customer | customer inquiries |
| | | | engagement | Call center |
| | | | for its products | initiatives |
| | | | and services | Customer |
| | | | | relationship |
| | | | | management |
| | | | | initiatives |
| | | Data privacy | Indicator of a | Number and cost of |
| | | | company's | data breaches that |
| | | | vulnerability to | released customer |
| | | | breaches | or personal data |
| | | | related to | Data security |
| | | | personal and | measures |
| | | | customer data | |
| | Community | Corporate | Indicator of a | Spend on |
| | engagement | philanthropy | company's | philanthropy |
| | | | commitment to | Spend on annual |
| | | | providing | donations |
| | | | philanthropy | Minimum time |
| | | | | since last donation |
| | | Community | Indicator of a | Number of “do |
| | | engagement | company's | good” events |
| | | | commitment to | Total revenue spent |
| | | | providing | on do-good |
| | | | resources and | initiatives |
| | | | channels for | Volunteer days per |
| | | | community | employee |
| | | | enhancement | |
| | Supplier | Supplier | Indicator of the | Slow and delayed |
| | engagement | engagement | quality of | payments to |
| | | | relationships | suppliers compared |
| | | | and | with industry |
| | | | engagement of | Negative payment |
| | | | a company | experiences by |
| | | | with its | suppliers |
| | | | suppliers | Presence of supply |
| | | | | chain initiatives |
| | Certifications | Social-related | Indicator of a | OHSAS 18001-, |
| | | certifications | company's | ISO 45001-, ISO |
| | | | commitment to | 26000-, ISO |
| | | | pursuing | 20400-certified |
| | | | formal | companies |
| | | | processes and | |
| | | | management | |
| | | | systems related | |
| | | | to social issues | |
| Governance | Corporate | Business ethics | Indicator of a | Ethical conduct |
| | governance | | company's | and policies (code |
| | | | commitment to | of conduct, |
| | | | conducting | committee charter, |
| | | | ethical | governance |
| | | | business | programs, |
| | | | practices | regulatory |
| | | | | programs) |
| | | | | Whistleblower and |
| | | | | grievance |
| | | | | mechanisms |
| | | | | History of |
| | | | | corruption or |
| | | | | misdeeds |
| | | Board | Indicator of | Board structure |
| | | accountability | accountability | Board diversity: |
| | | | measures | number of women |
| | | | present in a | on the board, |
| | | | company's | number of |
| | | | board of | minorities on the |
| | | | directors | board |
| | | | | Governance/conflict/auditing/compensation |
| | | | | committees |
| | | Shareholder | Indicator of the | Minority investors |
| | | rights | quality and use | protection |
| | | | of appropriate | Number of |
| | | | channels for | shareholder |
| | | | shareholders to | proposals and |
| | | | enact their | policies |
| | | | rights | ESG-related |
| | | | | shareholder |
| | | | | proposals and |
| | | | | policies |
| | | Business | Indicator of a | Transparency |
| | | transparency | company's | index, transparency |
| | | | commitment to | awards |
| | | | operating in a | Willingness to |
| | | | transparent and | provide ESG |
| | | | accountable | disclosure |
| | | | manner | Auditor details |
| | Corporate | Corporate | Indicator of | Sanctions list |
| | behaviors | compliance | adherence to | Awards list |
| | | behaviors | regulatory | Liabilities and |
| | | | requirements | lawsuits |
| | | | and absence of | Criminal activity |
| | | | liabilities | Government |
| | | | | inquiries |
| | | | | Accounting and |
| | | | | regulatory errors |
| | | Governance- | Indicator of | ISO 9000-, ISO |
| | | related | adherence to | 9001-, ISO 27001-, |
| | | certifications | formal | ISO 9002-, ISO |
| | | | governance | 55001-certified |
| | | | structures via | companies |
| | | | pursuit of | |
| | | | certifications | |
| | Business | Business | Indicator of a | Business activity |
| | resiliency | resiliency and | company's | related to preparing |
| | | stability | ability to be | for bankruptcy |
| | | | resilient | Business recovery |
| | | | against | from natural |
| | | | volatility, | disasters |
| | | | including | Meeting with |
| | | | economic- and | creditors |
| | | | weather- | Systemic risk |
| | | | related events | management |

Below, we explore how two ESG topics, supplier engagement and environmental opportunities, inform the final ESG rankings.

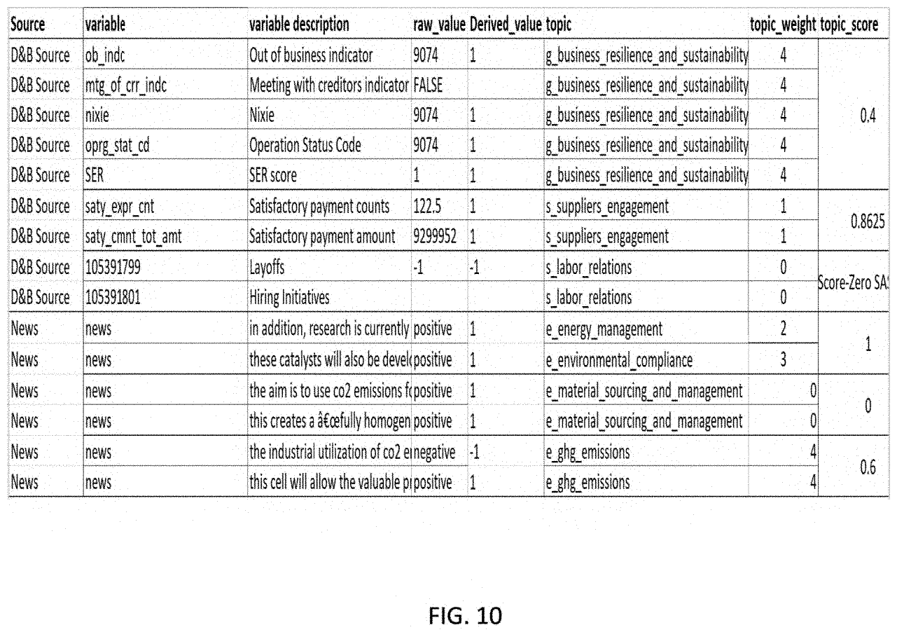

FIG. 10 is a table of example data for ESG topics of supplier engagement and environmental opportunities.

In this example, for a food retail and distribution company, we view a sample of input data from Dun & Bradstreet and the media. The “topic_weight” column indicates the weighting of the ESG topic as it relates to materiality for the agricultural products industry. The distinct variables and text data that relate to each of these topics are collected and aggregated via a weighted average to determine an ultimate topic score.

ESG topic scores are then aggregated using a weighted average on the theme level across the data sources to determine an overall ESG theme score.

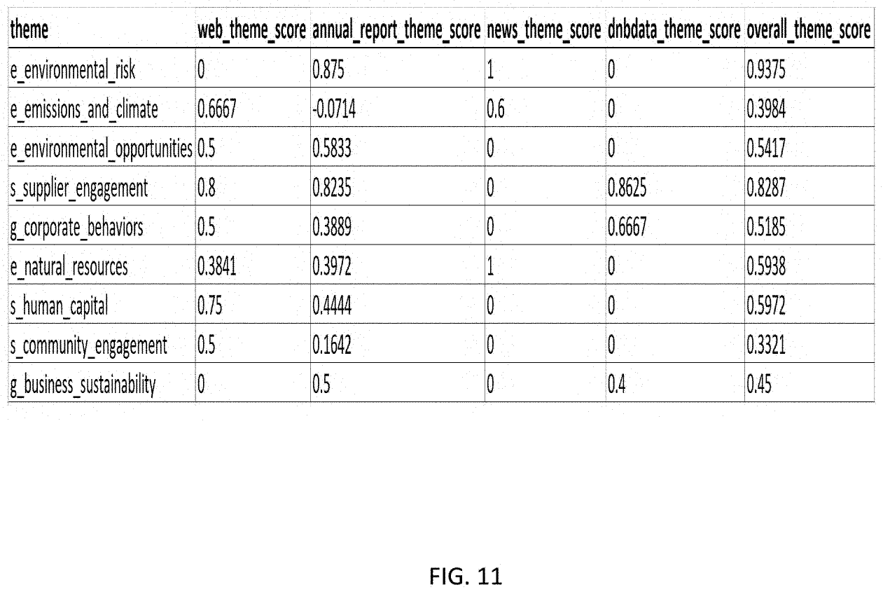

FIG. 11 is a table of illustrative scores for ESG themes across various data sources.

ESG theme scores then roll up to the average ESG factor scores across the E, S, G, and overall ESG dimensions.

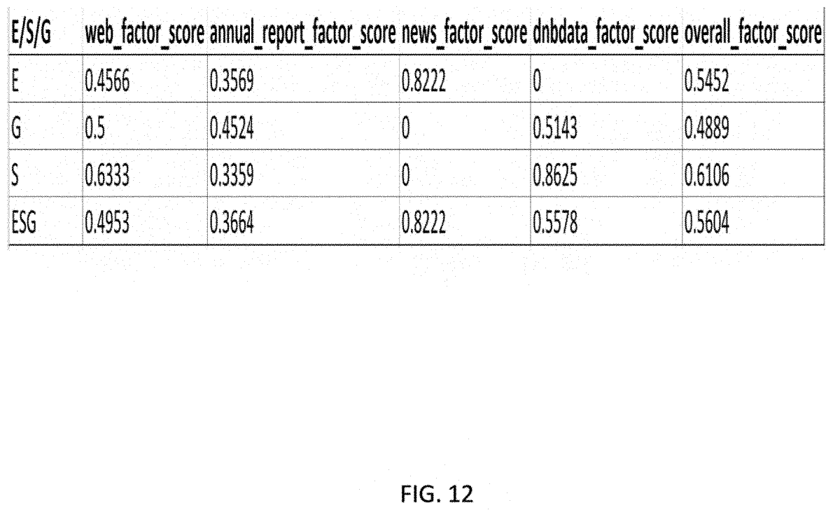

FIG. 12 is a table of overall ESG scores across sources.

The factor scores fall between distinct thresholds that then inform the final ESG rankings from 1 to 5, with 1 being the lowest risk company in the universe and 5 being the highest risk company.

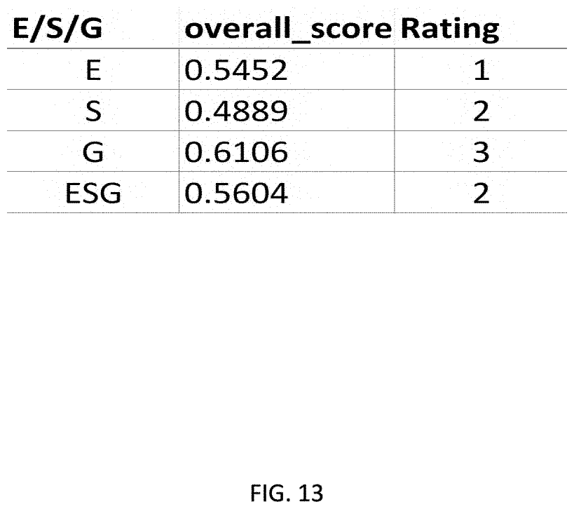

FIG. 13 is a table of overall ESG factor scores that fall between thresholds that then inform the final ESG rankings.

ESG Outputs

The ESG outputs are calculated to compose a dataset that results in a normal distribution of data between 1, indicating low risk or best performance, and 5, indicating high risk or worst performance. Cluster analysis on the company universe informs the number of thresholds (in this case 5), while thresholds are determined based on the standard deviation for the distribution of companies. This range is chosen in order to provide enough distinction between risk categories based on the available data that can conclusively express a risk factor on a reliable scale. For example, a company ranked 4 will have a significantly different risk profile than a company ranked 5, and even more so than a company ranked 1.

The main relationship of ESG data to company risk is captured when data is topically organized and aggregated to an overall metric. ESG data is also not generally rich enough to allow non-transparent calculation methods, which can occur with ML. As the dataset grows in both coverage and depth, there may be opportunities to identify specific variables that can contribute to ESG-related algorithms that benefit from ML.

The ESG rankings dataset is a ranking model and will adjust as the overall market improves and changes its ESG-related activities. The more companies implement management of ESG issues, the harder it will be for companies to remain in the top class. The model depicts placements based on observed behaviors and not a probability of a perceived change or exposure to risk, although historical observed behaviors can have a correlation to risk events that can result in financial, reputational or operational damages. Future developments of ESG data and analytics include development risk models that capture perceived change or exposure to an event.

ESG Rankings in Practice

To put the ESG rankings into practice, we use an example of a financial services company and its supply chain. This example illustrates how a business might assess its supplier network using different criteria for the three core components of ESG, i.e., environmental, social, and governance, to create a stronger and more resilient supply chain.

Assume an organization has 1,251 suppliers in its portfolio, with an overall ESG Ranking of 2.13, ahead of the industry average of 2.40. Most of its suppliers are high performing, but 36 suppliers give cause for concern and would warrant further investigation. Suppliers that are deemed to be too high risk can then be replaced by others, creating a stronger supply chain.

Related to environmental measures, the majority of the company's suppliers perform well, but 48 of those suppliers have poor or very poor performance. This is, in part, driven by 17 suppliers that have negative environmental compliance indicators related to fines or non-compliance, and concerns with some suppliers regarding their energy management, materials sourcing, waste management, climate risk, and water management.

Being associated with a supplier that has poor environmental credentials can damage the reputation of that supplier's customers. Furthermore, should a preventable environmental accident threaten the supply or shipping of goods or components, a customer-centric organization will find itself unable to meet the demands of its own customers, resulting in lost profits as well as a damaged reputation. Using sustainable sources and operating in a responsible fashion can reassure customers, senior leaders, shareholders, and supply chain managers.

On the social side, analysis suggests the majority of the company's suppliers have good or average performance, but there are concerns about several of them. This is partly due to negative supplier engagement, such as slow payment or poor communication, but there are also issues with the quality of products and services as well as data privacy related to security breaches of customer information.

The governance element for the financial services company is stronger, but there are concerns about a few suppliers, which would require further exploration. These revolve largely around business resilience, both in terms of financial stability and the ability to respond to climate events, but there are also some issues regarding corporate compliance, business ethics, and transparency.

Strong corporate governance practices are vital for organizations to be able to respond to operational problems, as well as cope with intensifying regulatory requirements, for instance, regarding diversity and equality or financial reporting. Using ESG data to manage a company's risk, such as through its suppliers, can help generate confidence that a company is unlikely to become caught up in regulatory or reputational issues, while having a stronger supply chain can act as a source of competitive advantage when it comes to winning new contracts.

ESG Self-Assessment

ESG Self-Assessment provides an additional channel for data collection and company validation of ESG data. Any collected information goes through additional verification processes, and once processed, is added to any existing ESG data on a company. The ESG Self-Assessment may include an online questionnaire composed of questions regarding ESG performance. The Self-Assessment references several of the main existing sustainability frameworks (e.g., the GRI, SASB, International Integrated Reporting Council, TCFD) as well as any current and emerging ESG-related regulatory frameworks (EU Taxonomy, SFDR, TCFD, etc.). It is complementary to the ESG rankings dataset and may streamline and prioritize specific ESG topics that are financially material to companies.

The ESG Self-Assessment is a mechanism for further data collection and company validation of data, but it also provides identification of the topics and areas where a company may want to focus its ESG strategies, especially as it moves through differing cycles of sustainability maturity. In conjunction with the ESG rankings, the ESG Self-Assessment helps companies identify current ESG-related gaps in its strategy, reveals areas of potential improvement, and can inform the creation of ESG short- and long-term targets and goals.

Applications for the ESG Rankings

The coverage and materiality focus of the ESG Rankings allow for myriad applications, especially wherever risk identification needs to occur across a wide range and number of companies. The ESG Rankings dataset can be useful, for example, for the following positions.

Procurement Leader

Use case: Evaluating the ESG performance of a large portfolio of third-party vendors or suppliers.

Applications: Prioritizing monitoring or engaging with highest-risk or lowest-risk suppliers; evaluating hotspots of ESG risk among suppliers and throughout tiers; identifying suppliers to assist with corporate-led sustainability goals; identifying low-risk suppliers with which to build relationships by increasing spending or awarding long-term contracts or preferred contract terms.

Investment Manager

Use case: Evaluating the ESG performance of a large portfolio composed of public and/or private equity companies.

Applications: Identifying public and/or private equity companies that will provide or impact additional returns using ESG risk as a proxy; identifying public and/or private equity companies that contribute to impact or thematic investing for portfolio composition; reporting and disclosing ESG-related data to regulators, asset managers, or other financial institutions.

Business Sustainability Manager

Use case: Comparing company ESG performance; informing corporate sustainability strategy and/or reporting.

Applications: Benchmarking company ESG performance compared with industry or competitive peers; evaluating ESG performance of a company's customers to inform sustainability strategies, including product development, customer engagement, or goal setting; evaluating ESG performance of a company's supply chain to inform reporting, strategy, or target setting.

Banking/Credit Evaluator

Use case: Inputting the data into the lending, due diligence, or credit evaluation of companies.

Applications: Considering ESG issues when evaluating credit worthiness; inputting for offering preferred lending rates to low-risk companies; evaluating and stress testing loan books using ESG as a parameter; incorporating ESG issues as part of due diligence and KYC (know your customer) during onboarding.

Insurance Underwriter/Analyst

Use case: Inputting the data into pricing models; identifying risk throughout a company's portfolio.

Applications: Inputting into actuarial models for determining insurance premiums; identifying low-risk companies that may be candidates for insurance syndicates; evaluating company and supplier tier risks throughout the insurance portfolio.

Sales and Marketing Manager

Use case: Identifying specific market segmentations based on ESG characteristics.

Applications: Identifying sustainability-forward companies that may be interested in specific products or services; identifying sustainability-laggard companies that may be interested in specific products or services; inputting into market segmentation exercises to identify new markets and market penetration strategies.

### Example 1

Assume XYZ wants to access ABC's ESG score. To initiate the ranking method of system 100, XYZ initiates operation 205.

In operation 205, XYZ wants to access ABC's ESG score as per the ESG components in FIG. 8. In FIG. 8, under each of the environmental (E), social (S), and governance (G) dimensions, specific themes are described, as well as another layer of specific topics that relate to each general theme.

In operation 210, based on the information from operation 205, a set of significant N-Grams for each component (topic) is created. These N-Grams are keywords that are ontology-specific to the ESG components.

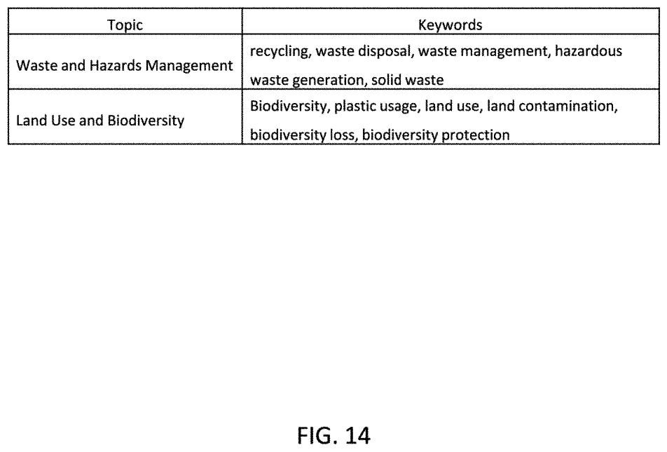

FIG. 14 is a table of the keywords related to topics, namely, (a) waste and hazards management, and (b) land use and biodiversity.

In operation 215, take N-grams from operation 210, and collect and generate big data (see FIG. 3).

Data is obtained from data sources 310, e.g., Dun & Bradstreet databases and 3rd party data.

In operation 350, data from data sources 310 is subjected to transformations/calculations to convert to ESG ingestible values.

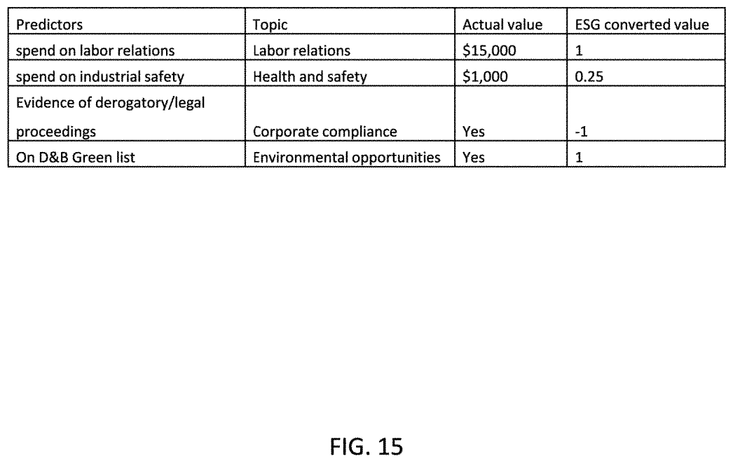

FIG. 15 is a table of examples of some predictors used in ESG. Raw values of predictors are converted to a scale of −1 to 1 based on impact of predictor where −1 represents the most risk or negative impact and 1 represents the positive impact or least risk.

Other data sources for the ESG Rankings dataset include:
(a) Data sources 315, e.g., public data sources—company websites, 10K/CSR/other ESG related reports;
(b) Data sources 335, e.g., data from highly reliable web sources that have rich ESG data pertaining to different companies; and
(c) Data sources 340, e.g., global news data related to companies.

Text data from data sources 315, 335 and 340 is collected and processed as follows.

In operation 355, data from web domains related to data sources 315 and 335 are collected by first identifying the company domain, and then extracting the ESG-specific data present in the company's website. (See FIG. 4, operations 405 and 410)

In operation 360, news data from data sources 340 is received from a premier news provider via file transfer protocol server, and then undergoes mapping for numeric identifier of business entity to identify the company corresponding to the news received. (See FIG. 5, operations 505 and 510.)

Data collected above is processed as follows.

Method 600 performs NLP and topic and theme tagging (See FIG. 6). Text data collected as paragraphs/documents is split to sentence level, and then these sentences are preprocessed by removing special characters and other text cleaning operations.

Method 700 performs sentiment analysis (See FIG. 7). The polarity/sentiment (positive, negative, neutral) of the preprocessed ESG sentences is determined using BERT/Zero shot models.

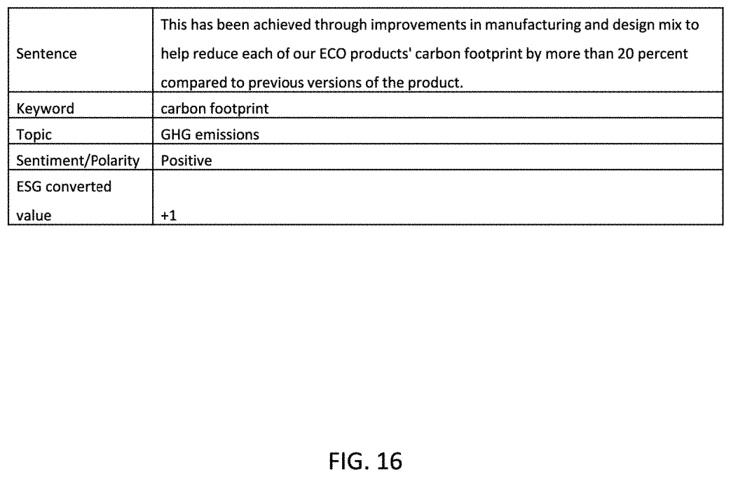

FIG. 16 is a table of an example of execution of methods 600 and 700, which shows the ESG theme and topic tagging of text data and arriving the ESG converted value based on polarity. Positive polarity results to a value of +1, negative polarity is assigned a value of −1, and neutral polarity is assigned to a value of 0.

Operation 220 creates component weights for each business segment through existing literature/standards. These topic-specific weights are based on the importance, or materiality, of that topic to the company's sector.

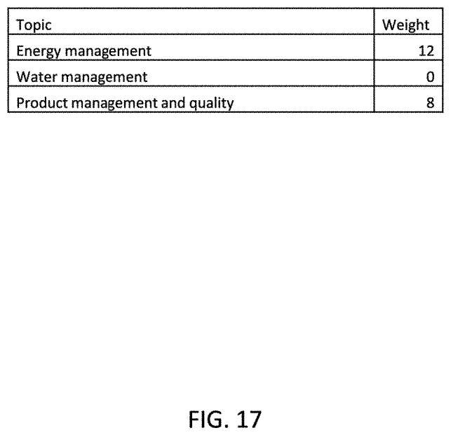

FIG. 17 is a table of topic weights related to a sector for gas utilities and distributors as per the literature/standards.

The processed data from all the sources of operation 215 is now subjected to ESG score calculation using component weights of operation 220.

At each data source level, each ESG component score is calculated as follows.

Topic score is calculated based on average of processed data values. Some topic scores are also overridden based on Blacklists/certifications data.

Theme score is calculated by weighted average of corresponding topic scores. For instance, a score for a Natural resources theme is calculated.

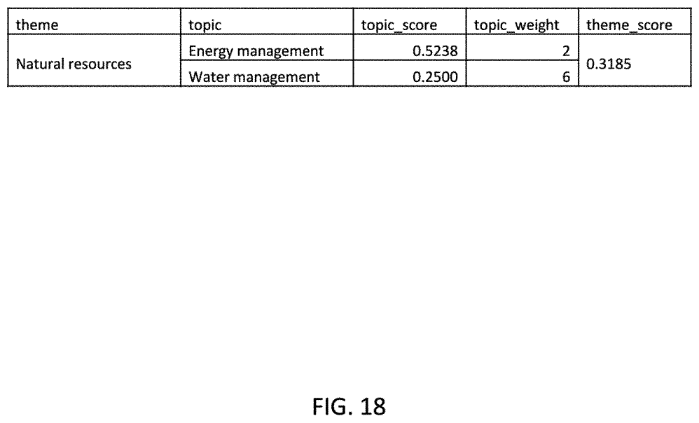

FIG. 18 is a table of an example calculation of the score for the Natural resources theme.

Dimension score (environment/social/governance) is obtained by weighted average of corresponding topic scores.

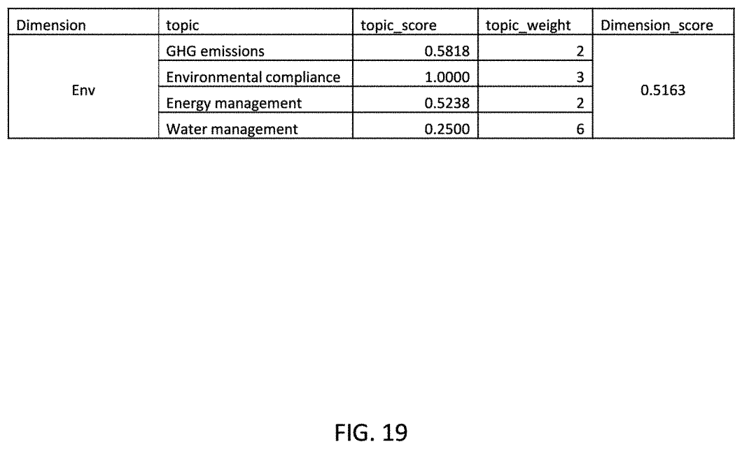

FIG. 19 is a table of an example calculation of an environment score.

The ESG score of a data source is then calculated by weighted average of all available topic scores.

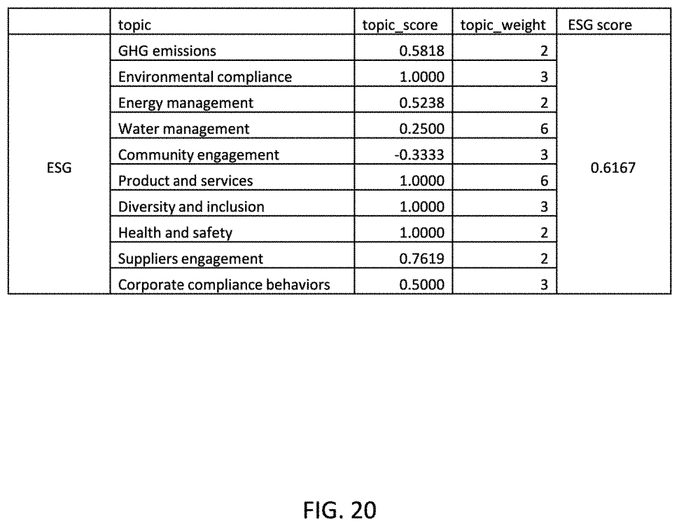

FIG. 20 is a table of an exemplary calculation of an ESG score. The overall ESG score ranges at a scale of −1 to 1 where −1 represents the most risk or negative impact, and 1 represents the positive impact or least risk.

The overall score of each component is then obtained by average scores of all available sources.

Based on the statistical distributions of component scores, thresholds are derived and applied accordingly for each component to assign ESG rankings/scores.

For the companies that have no ESG scores but belong to the family tree of a corporate entity with ESG score and same business sector, ESG scores are given based on nearest hierarchy within that family tree.

As a final step, in operation 230, ESG fields/results will be transferred to a platform from which a user, e.g., user 135, will be able to access the ESG scores.

The process disclosed herein, of creating quality ESG outputs, is a straightforward, mathematical manner to create data that provides a clear understanding of our methodology at the same time adhering to several of the leading ESG standards.

Thus, in system 100, pursuant to instructions in program module 120, processor 110 performs operations of (a) receiving data indicative of an environmental (E), social (S) and governance (G) objective, and measurements of ESG components, (b) creating a set of N-grams for each ESG component, (c) searching a database, based on the set of N-grams, to obtain ESG data, and (d) generating an ESG score based on the ESG data.

Generating the ESG score based on the ESG data may include creating a component weight for a business segment.

Creating a component weight may be performed by a machine learning component.

Generating the ESG score may include (a) obtaining website data from a website for a business based on the ESG data, (b) natural language processing (NLP) of the website data, thus yielding a tag, (c) performing a sentiment analysis on the tag, thus yielding a sentiment, and (d) utilizing the tag and the sentiment to generate the ESG score.

Obtaining website data may include domain mapping the business to the website, and web scrapping the website to obtain the website data.

Obtaining website data may also include (a) obtaining news concerning the ESG data, and (b) mapping the business to the website based on the news.

NLP may include (a) tokenizing text data from the website into a sentence, (b) tagging the sentence to E, S and G multigrams, (c) tagging the sentence to a theme and topic under E, S and G dimensions based on the E, S and G multigrams, and (d) shortlisting the sentence in response to the sentence having at least one E, S or G mention, thus yielding a shortlisted sentence.

Sentiment analysis may include (a) analyzing the shortlisted sentence utilizing a machine learning model, thus yielding an analyzed sentence, (b) tagging a polarity of the analyzed sentence, thus yielding a polarity, (c) aggregating sentiment for the business for the theme and topic based on the polarity, thus yielding aggregated data, and (d) calculating an index based on the aggregated data.

The techniques described herein are exemplary, and should not be construed as implying any particular limitation on the present disclosure. It should be understood that various alternatives, combinations and modifications could be devised by those skilled in the art. For example, operations associated with the processes described herein can be performed in any order, unless otherwise specified or dictated by the operations themselves. The present disclosure is intended to embrace all such alternatives, modifications and variances that fall within the scope of the appended claims.

The terms “comprises” or “comprising” are to be interpreted as specifying the presence of the stated features, integers, operations or components, but not precluding the presence of one or more other features, integers, operations or components or groups thereof. The terms “a” and “an” are indefinite articles, and as such, do not preclude embodiments having pluralities of articles.

What is claimed is:

1. A method comprising:
receiving data indicative of an environmental (E), social (S) and governance (G) objective, and measurements of ESG components;
creating a set of N-grams for each ESG component;
searching a database, based on said set of N-grams, to obtain ESG data; and
generating an ESG score based on said ESG data.

2. The method of claim 1, wherein said generating includes creating a component weight for a business segment.

3. The method of claim 2, wherein said creating a component weight is performed by a machine learning component.

4. The method of claim 1, wherein said generating includes:
obtaining website data from a website for a business based on said ESG data;
natural language processing (NLP) of said website data, thus yielding a tag;
performing a sentiment analysis on said tag, thus yielding a sentiment; and
utilizing said tag and said sentiment to generate said ESG score.

5. The method of claim 4, wherein said obtaining includes:
domain mapping said business to said website; and
web scrapping said website to obtain said website data.

6. The method of claim 4, wherein said obtaining includes:
obtaining news concerning said ESG data; and
mapping said business to said website based on said news.

7. The method of claim 4, wherein said NLP includes:
tokenizing text data from said website into a sentence;
tagging said sentence to E, S and G multigrams;
tagging said sentence to a theme and topic under E, S and G dimensions based on said E, S and G multigrams; and
shortlisting said sentence in response to said sentence having at least one E, S or G mention, thus yielding a shortlisted sentence.

8. The method of claim 7, wherein said sentiment analysis includes:
analyzing said shortlisted sentence utilizing a machine learning model, thus yielding an analyzed sentence;
tagging a polarity of said analyzed sentence, thus yielding a polarity;
aggregating sentiment for said business for said theme and topic based on said polarity, thus yielding aggregated data; and
calculating an index based on said aggregated data.

9. A system comprising:
a processor; and
a memory that contains instructions that are readable by said processor to cause said processor to perform operations of:
receiving data indicative of an environmental (E), social (S) and governance (G) objective, and measurements of ESG components;
creating a set of N-grams for each ESG component;
searching a database, based on said set of N-grams, to obtain ESG data; and
generating an ESG score based on said ESG data.

10. The system of claim 9, wherein said generating includes creating a component weight for a business segment.

11. The system of claim 10, wherein said creating a component weight is performed by a machine learning component.

12. The system of claim 9, wherein said generating includes:
obtaining website data from a website for a business based on said ESG data;
natural language processing (NLP) of said website data, thus yielding a tag;
performing a sentiment analysis on said tag, thus yielding a sentiment; and
utilizing said tag and said sentiment to generate said ESG score.

13. The system of claim 12, wherein said obtaining includes:
domain mapping said business to said website; and
web scrapping said website to obtain said website data.

14. The system of claim 12, wherein said obtaining includes:
obtaining news concerning said ESG data; and
mapping said business to said website based on said news.

15. The system of claim 12, wherein said NLP includes:
tokenizing text data from said website into a sentence;
tagging said sentence to E, S and G multigrams;
tagging said sentence to a theme and topic under E, S and G dimensions based on said E, S and G multigrams; and
shortlisting said sentence in response to said sentence having at least one E, S or G mention, thus yielding a shortlisted sentence.

16. The system of claim 15, wherein said sentiment analysis includes:
analyzing said shortlisted sentence utilizing a machine learning model, thus yielding an analyzed sentence;
tagging a polarity of said analyzed sentence, thus yielding a polarity;
aggregating sentiment for said business for said theme and topic based on said polarity, thus yielding aggregated data; and
calculating an index based on said aggregated data.

17. A storage device in non-transitory form, comprising:
instructions that are readable by a processor to cause said processor to perform operations of:
receiving data indicative of an environmental (E), social (S) and governance (G) objective, and measurements of ESG components;
creating a set of N-grams for each ESG component;
searching a database, based on said set of N-grams, to obtain ESG data; and
generating an ESG score based on said ESG data.

18. The storage device of claim 17, wherein said generating includes creating a component weight for a business segment.

19. The storage device of claim 18, wherein said creating a component weight is performed by a machine learning component.

20. The storage device of claim 17, wherein said generating includes:
obtaining website data from a website for a business based on said ESG data;
natural language processing (NLP) of said website data, thus yielding a tag;
performing a sentiment analysis on said tag, thus yielding a sentiment; and
utilizing said tag and said sentiment to generate said ESG score.

21. The storage device of claim 20, wherein said obtaining includes:
domain mapping said business to said website; and
web scrapping said website to obtain said website data.

22. The storage device of claim 20, wherein said obtaining includes:
obtaining news concerning said ESG data; and
mapping said business to said website based on said news.

23. The storage device of claim 20, wherein said NLP includes:
tokenizing text data from said website into a sentence;
tagging said sentence to E, S and G multigrams;
tagging said sentence to a theme and topic under E, S and G dimensions based on said E, S and G multigrams; and
shortlisting said sentence in response to said sentence having at least one E, S or G mention, thus yielding a shortlisted sentence.

24. The storage device of claim 23, wherein said sentiment analysis includes:
analyzing said shortlisted sentence utilizing a machine learning model, thus yielding an analyzed sentence;
tagging a polarity of said analyzed sentence, thus yielding a polarity;
aggregating sentiment for said business for said theme and topic based on said polarity, thus yielding aggregated data; and
calculating an index based on said aggregated data.
